(19) United States
(12) Patent Application Publication
(10) Pub. No.: US 2022/0245502 A1
(43) Pub. Date: Aug. 4, 2022

(54) EXPLANATION OF MACHINE LEARNING MODELS USING A PROCESS-AWARE NEIGHBORHOOD SAMPLING PROCEDURE

(71) Applicant: International Business Machines Corporation, Armonk, NY (US)

(72) Inventors: Vatche Isahagian, Belmont, MA (US); Vinod Muthusamy, Austin, TX (US); Yara Rizk, Cambridge, MA (US); Sohini Upadhyay, Cambridge, MA (US)

(21) Appl. No.: 17/161,663

(22) Filed: Jan. 29, 2021

(51) Int. Cl. G06N 20/00; G06K 9/62

(52) U.S. Cl. CPC G06N 20/00; G06K 9/6215

(57) ABSTRACT

A computer-implemented method, a computer program product, and a computer system for explaining black-box machine learning models. A computer or server determines a process-aware neighborhood around a data sample, using one or more business process rules. The computer or server computes proximity between the process-aware neighborhood and the data sample, using a process-aware distance metric. The computer or server finds, from a family of linear functions, a local linear model, by minimizing losses of respective ones of the linear functions and a black-box machine learning model. The computer or server provides the local linear model for explanation of output of the black-box model on the data sample.

### BACKGROUND

The present invention relates generally to explanation of machine learning models, and more particularly to a local explanation framework for explaining machine learning models using a process-aware neighborhood sampling procedure.

Business processes are an integral part of several industries, including government, insurance, banking and healthcare. Examples of such processes include loan origination, invoice management, automobile insurance claims processing, handling prescription drug orders, and patient case management.

Recent advancements in artificial intelligence (AI) represent a great opportunity for infusing AI to some fields, such as predict outcomes, reduce cost or provide better customer experience, and recommend decisions. Most recently, deep learning models have been used to make outcome and time to-complete predictions.

AI business process applications are desired to have ability to explain model decisions. For example, in a mortgage loan application, in the United States, the Federal Trade Commission guidelines dictate that if consumers are denied something of value (i.e., a loan) based on AI, they are entitled to an explanation. Furthermore, the guidelines state that when assigning risk scores to consumers, the key features affecting the risk scores ought to be disclosed in rank order of importance. In the credit scoring domain, this right to an explanation is protected under the Equal Credit Opportunity Act. The European Union guarantees the right to explanation across a broader range of domains under the General Data Protection Regulation (GDPR).

The AI community has made significant advancements in the domain of explanation approaches, with explainability tools, such as local interpretable model-agnostic explanations (LIME) (Ribeiro, et al., “Why should I trust you? Explaining the predictions of any classifier”, 22nd ACM SIGKDD, 2016) and SHapley Additive exPlanations (SHAP) (Lundberg, et al., A Unified Approach to Interpreting Model Predictions, 31st Conference on Neural Information Processing Systems, 2017). Unfortunately, applying these approaches to business process management (BPM) models directly results in potentially misleading explanations (Jan, et al., AI Trust in business processes: The need for process-aware explanations, arXiv:2001.07537v1, 2020).

### SUMMARY

In one aspect, a computer-implemented method for explaining black-box machine learning models is provided. The computer-implemented method includes determining a process-aware neighborhood around a data sample, using one or more business process rules. The computer-implemented method further includes computing proximity between the process-aware neighborhood and the data sample, using a process-aware distance metric. The computer-implemented method further includes finding, from a family of linear functions, a local linear model, by minimizing losses between respective ones of the linear functions and a black-box machine learning model. The computer-implemented method further includes providing the local linear model for explanation of output of the black-box model on the data sample.

The computer-implemented method further includes receiving the data sample, the black-box machine learning model, the one or more business process rules, the process-aware distance metric, and hyperparameters. In the computer-implemented method, the hyperparameters include parameters of the one or more business process rules. In the computer-implemented method, minimizing the losses is weighted with the proximity. The computer-implemented method further includes, in finding the local linear model, penalizing linear model complexity. The computer-implemented method further includes providing feature coefficients of the local linear model for the explanation of the output of the black-box model on the data sample. In the computer-implemented method, the process-aware distance metric is a distance metric that is suitable for a data distribution corresponding to the one or more business process rules.

In another aspect, a computer program product for explaining black-box machine learning models is provided. The computer program product comprises a computer readable storage medium having program instructions embodied therewith, and the program instructions are executable by one or more processors. The program instructions are executable to: determine a process-aware neighborhood around a data sample, using one or more business process rules; compute proximity between the process-aware neighborhood and the data sample, using a process-aware distance metric; find, from a family of linear functions, a local linear model, by minimizing losses between respective ones of the linear functions and a black-box machine learning model; and provide the local linear model for explanation of output of the black-box model on the data sample.

The program instructions of the computer program product are further executable to receive the data sample, the black-box machine learning model, the one or more business process rules, the process-aware distance metric, and hyperparameters, where the hyperparameters include parameters of the one or more business process rules. In the program instructions of the computer program product, minimizing the losses is weighted with the proximity. The program instructions of the computer program product are further executable to, in finding the local linear model, penalize linear model complexity. The program instructions of the computer program product are further executable to provide feature coefficients of the local linear model for the explanation of the output of the black-box model on the data sample. In the program instructions of the computer program product, the process-aware distance metric is a distance metric that is suitable for a data distribution corresponding to the one or more business process rules.

In yet another aspect, a computer system for explaining black-box machine learning models is provided. The computer system comprises one or more processors, one or more computer readable tangible storage devices, and program instructions stored on at least one of the one or more computer readable tangible storage devices for execution by at least one of the one or more processors. The program instructions are executable to determine a process-aware neighborhood around a data sample, using one or more business process rules. The program instructions are further executable to compute proximity between the process-aware neighborhood and the data sample, using a process-aware distance metric. The program instructions are further executable to find, from a family of linear functions, a local linear model, by minimizing losses between respective ones of the linear functions and a black-box machine learning model. The program instructions are further executable to provide the local linear model for explanation of output of the black-box model on the data sample.

The program instructions of the computer system are further executable to receive the data sample, the black-box machine learning model, the one or more business process rules, the process-aware distance metric, and hyperparameters, where the hyperparameters include parameters of the one or more business process rules. In the program instructions of the computer system, minimizing the losses is weighted with the proximity. The program instructions of the computer system are further executable to, in finding the local linear model, penalize linear model complexity. The program instructions of the computer system are further executable to provide feature coefficients of the local linear model for the explanation of the output of the black-box model on the data sample. In the program instructions of the computer system, the process-aware distance metric is a distance metric that is suitable for a data distribution corresponding to the one or more business process rules.

### BRIEF DESCRIPTION OF THE SEVERAL VIEWS OF THE DRAWINGS

FIG. 1 is a systematic diagram illustrating a local explanation framework for explaining black-box machine learning models, in accordance with one embodiment of the present invention.

FIG. 2 presents a flowchart showing operational steps for explaining a black-box machine learning model, in accordance with one embodiment of the present invention.

FIG. 3 presents a data distribution of a loan approval dataset, in accordance with one embodiment of the present invention.

FIG. 4 presents loan approval predictions by a black-box machine learning model, in accordance with one embodiment of the present invention.

FIG. 5 is a diagram illustrating components of a computing device or server, in accordance with one embodiment of the present invention.

FIG. 6 depicts a cloud computing environment, in accordance with one embodiment of the present invention.

FIG. 7 depicts abstraction model layers in a cloud computing environment, in accordance with one embodiment of the present invention.

### DETAILED DESCRIPTION

Artificial intelligence (AI) business process applications automate high-stakes business decisions where there is an increasing demand to justify or explain the rationale behind algorithmic decisions. Business process applications have ordering or constraints on tasks and feature values that cause lightweight, model-agnostic, existing explanation methods such as local interpretable model-agnostic explanations (LIME) fail. Embodiments of the present invention propose a local explanation framework extending LIME for explaining AI business process applications.

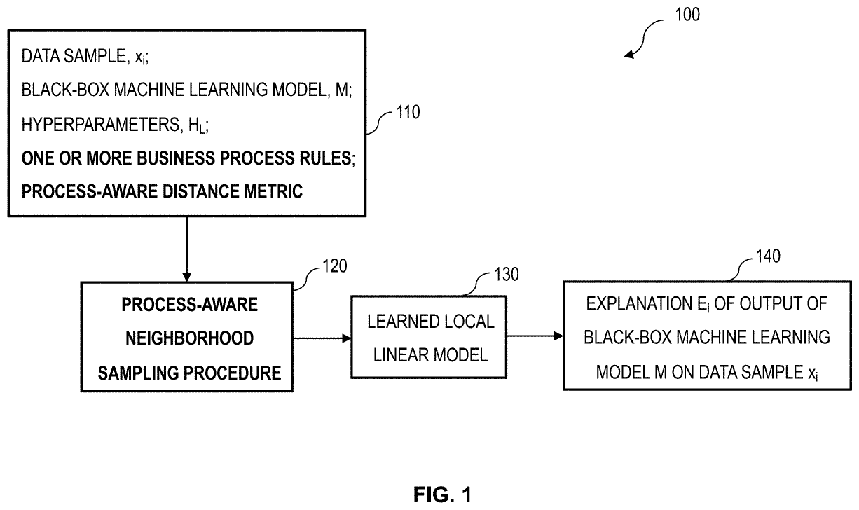

In embodiments of the present invention, an extension to LIME for business process applications is proposed. LIME is extended by modularizing its neighborhood sampling component and exposing it to subject matter experts to define on an application basis according to relevant business process rules. FIG. 1 is a systematic diagram illustrating local explanation framework 100 for explaining black-box machine learning models, in accordance with one embodiment of the present invention. Local explanation framework 100 is an extension of LIME. In local explanation framework 100, as shown by block 110 in FIG. 1, a data sample xᵢ which includes feature values, a black-box model M, and a set of LIME hyperparameters H_{L} are given. As shown by block 110 in FIG. 1, contrary to standard LIME, one or more business process rules and a process-aware distance metric are given. Local explanation framework 100 includes process-aware neighborhood sampling procedure 120. With process-aware neighborhood sampling procedure 120, local explanation framework 100 uses a specific sampling rule to sample a random neighborhood around xᵢ.

Local explanation framework 100 includes learned local linear model 130. Local explanation framework 100 learns a local linear model mirroring the behavior of the black-box machine learning model M on the neighborhood around xᵢ. As shown by block 140 in FIG. 1, local explanation framework 100 returns an explanation Eᵢ of the output of the black-box machine learning model M on xᵢ in terms of feature coefficients in the learned local linear model.

Local explanation framework 100 receives a data sample xᵢ and a black-box machine learning model M as input, and local explanation framework 100 samples a neighborhood Nᵢ around xᵢ. In standard LIME in the art (Ribeiro, et al., “Why should I trust you? Explaining the predictions of any classifier”, 22nd ACM SIGKDD, 2016), the neighborhood Nᵢ is continuous valued data differently depending on the choice of certain LIME hyperparameters μᵢ, ∈ᵢ∈H_{L}, where μᵢ dictates where to center the neighborhood Nᵢ and ∈ᵢ determines what type of random noise to use. Choices for μᵢ center around the sample, μₓ, or around the training data mean, μₘ. Choices for ∈ᵢ are Gaussian noise, ∈_{g}, or Latin hypercube sampling (LHS) noise, ∈ₗ. Given LIME hyperparameters μᵢ and ∈ᵢ, standard LIME in the art samples a neighborhood Nᵢ according to the following form:

xᵢ′=μᵢ+∈ᵢ (1)

In embodiments of the present invention, local explanation framework 100 specifies new sampling rules based on the one or more business process rules. For example, given a business process rule

xᵢ˜ [symbol] (μ,Σ), (2)

local explanation framework 100 generates process-aware samples directly based on the data distribution such that samples in Nᵢ take on the following form:

xᵢ′ [symbol] (μ,Σ). (3)

Once a neighborhood Nᵢ is generated, local explanation framework 100 determines a local linear model fᵢ. The local linear model fᵢ mirrors black-box machine learning model M on neighborhood Nᵢ. The local linear model fᵢ is found through the following optimization:

$${f}_{i} = \begin{matrix}argmin \\ f ∈ F\end{matrix} ℒ ( M , f , {π}_{x} ) + Ω ( f ) . \qquad ( 4 )$$

The feature coefficients of fᵢ then dictates an explanation of E₁ of the output of the black-box machine learning model Mon xᵢ. In the local linear model fᵢ, F is the family of linear functions, [symbol] is a weighted loss function, πₓ=πₓ(z) is a weight function measuring the proximity between x=xᵢ and z=xᵢ′, and Ω is a function penalizing complexity. These parameters are set when specifying H_{L}. In experiments discussed in later paragraphs of this document, F is the family of logistic regression functions, [symbol] is weighted square loss, Ω is L₂ regression. The definition of πₓ(z) is given by Ribeiro, et al. (“Why should I trust you? Explaining the predictions of any classifier”, 22nd ACM SIGKDD, 2016), which is an exponential kernel of the form:

$${π}_{x} ( z ) = exp ( \frac{- {D ( x , z )}^{2}}{{σ}^{2}} ) \qquad ( 5 )$$

for D, σ∈H_{L}, where D is a distance function and σ is referred to as kernel width. σ dictates how large the radius of Nᵢ should be.

The approach of the process-aware neighborhood sampling and the process-aware distance metric can be applied to similar explainable AI methods (such as SHapley Additive exPlanations (SHAP)) where neighborhood sampling is also employed and the same out-of-distribution problem is observed.

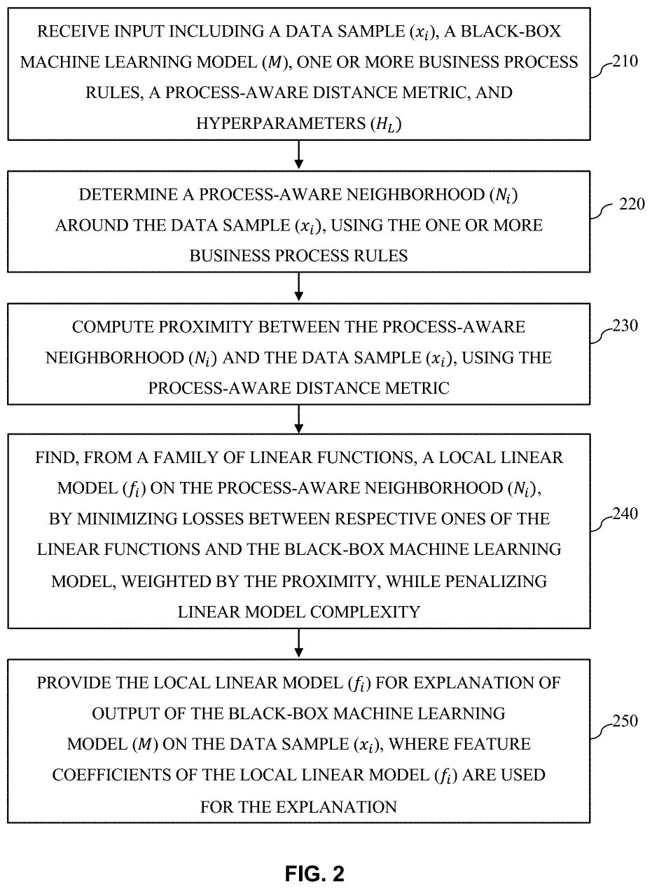

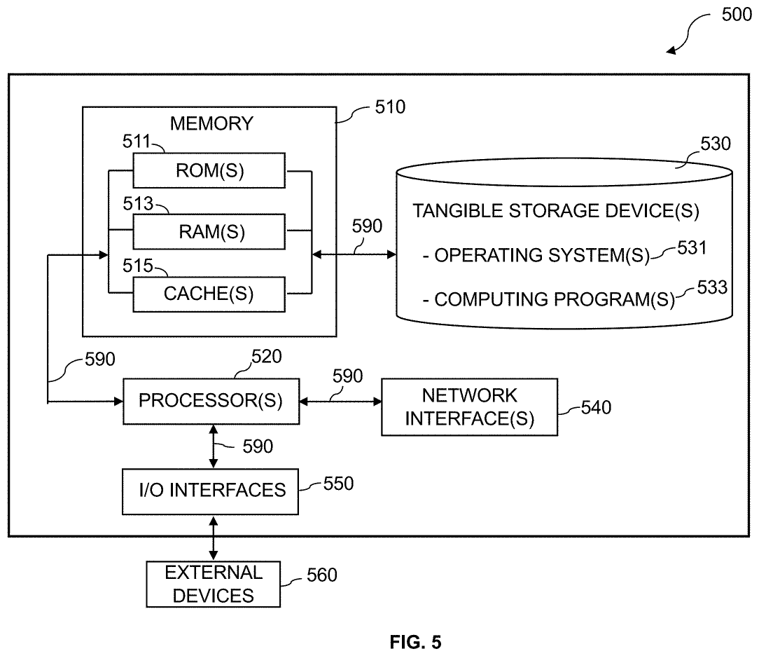

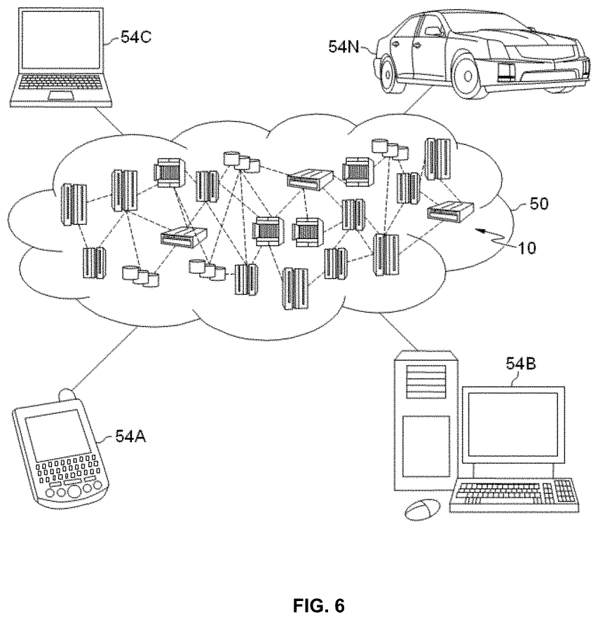

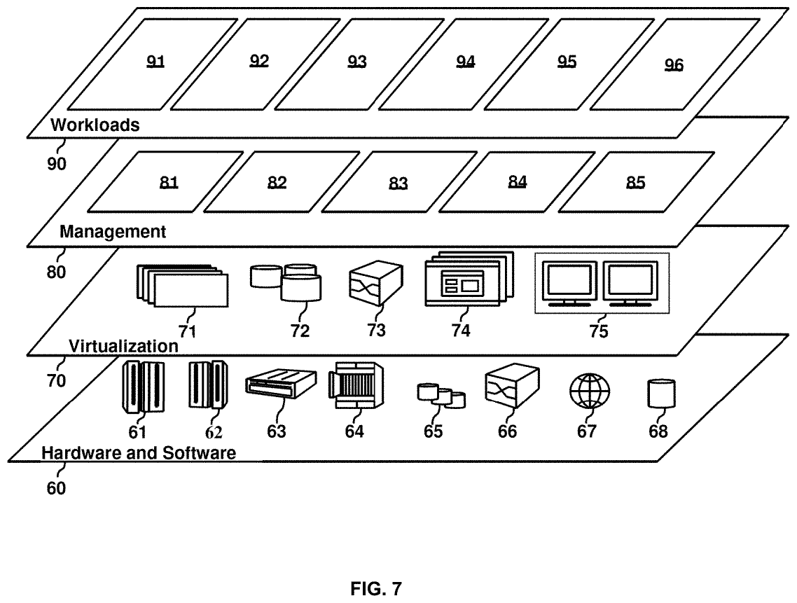

FIG. 2 presents a flowchart showing operational steps for explaining a black-box machine learning model, in accordance with one embodiment of the present invention. The operational steps are implemented on one or more computing devices or servers. A computing device or server is described in more detail in later paragraphs with reference to FIG. 5. In another embodiment, the operational steps may be implemented on a virtual machine or another virtualization implementation being run on one or more computing devices or servers. In yet another embodiment, the operational steps may be implemented in a cloud computing environment. The cloud computing environment is described in later paragraphs with reference to FIG. 6 and FIG. 7.

At step 210, the computing device or server receives input including a data sample (xᵢ), a black-box machine learning model (M), one or more business process rules, a process-aware distance metric, and hyperparameters (H_{L}). The data sample (xᵢ) includes feature values. The black-box machine learning model (M) is an machine learning model for which is model-agnostic explanation on the data sample (xᵢ) is desired. Hyperparameters (H_{L}) include parameters of the one or more business process rules. For example, if a business process rule is given as the Gaussian distribution xᵢ˜ [symbol] (μ, Σ) as described in equation (2), the hyperparameters include the parameters μ and Σ of the Gaussian distribution. A process-aware distance metric is a distance metric that is suitable for the data distribution (for example, the Gaussian distribution mentioned above) corresponding to the one or more business process rules.

At step 220, the computing device or server determines a process-aware neighborhood (Nᵢ) around the data sample (xᵢ), using the one or more business process rules received at step 210. For example, if a business process rule is given as the Gaussian distribution, the computing device or server will determine process-aware neighborhood (Nᵢ) based on equation (3) given in a previous paragraph: xᵢ′˜ [symbol] (μ, Σ), where parameters μ and Σ have been received at step 210. The one or more business process rules have been known; therefore, a neighborhood around the data sample (xᵢ) is a process-aware neighborhood. In other embodiments, the one or more business process rules that may direct the process-aware sampling include an optional process step, an optional process order, a process order, a known correlation, and a known shift of a model or rule.

At step 230, the computing device or server computes proximity between the process-aware neighborhood (Nᵢ) and the data sample (xᵢ), using the process-aware distance metric received at step 210. As described in a previous paragraph, πₓ=πₓ(z) is a weight function measuring the proximity between the process-aware neighborhood and the data sample, and it can be calculated by using equation (5) given in a previous paragraph. In equation (5), the distance function is used and it is a process-aware distance metric, which is suitable for the data distribution such as Gaussian distribution described in equation (2). In other embodiments, process-aware distance metrics may add a higher level of specificity to distances between mixed or categorical variables; therefore, the process-aware distance metrics become more specific to a process as opposed to general or generic. For example, the process-aware distance metrics may combine business category knowledge with standard distance metrics such as Euclidean, cosine, matching, and Jaccard.

At step 240, the computing device or server finds, from a family of linear functions, a local linear model (fᵢ) on the process-aware neighborhood (Nᵢ), by minimizing losses between respective ones of the linear functions and the black-box machine learning model, weighted by the proximity, while penalizing linear model complexity. Equation (4) given in a previous paragraph of this document describes finding the local linear model (fᵢ) on the process-aware neighborhood (NO. As described in equation (4), a weighted loss function ( [symbol] ) is minimized. Minimizing the weighted loss function ( [symbol] ) includes minimizing losses between respective ones of the linear functions in the family (f∈F) and the black-box machine learning model (M), and minimizing the losses is weighted by the proximity. As described in equation (4), finding the local linear model (fᵢ) further includes penalizing linear model complexity.

At step 250, the computing device or server provides the local linear model (fᵢ) for explanation of output of the black-box machine learning model (M) on the data sample (xᵢ), where feature coefficients of the local linear model (fᵢ) are used for the explanation.

To illustrate explanation of the black-box machine learning model, a mortgage loan application process was studied as an example. A mortgage loan application is an example of a business process where the process flow is the set of linked tasks such as collecting client related data (e.g., verifying employment, requesting credit report, performing a title search, risk assessment, and so on). The goal of the process is to approve or reject a loan application once all the required tasks are fully executed. We illustrated how expended LIME was embodied and how expended LIME mitigated the out-of-distribution problem in a simulation.

In the example of the mortgage loan application process, a loan approval dataset was simulated, and the loan approval dataset captures the scenario where features of credit and risk were inversely correlated. The correlation coefficient ρ between the credit and the risk was fixed as ρ=−0.9, and 10,000 samples were generated from a bivariate Gaussian distribution D with μ=[0, 0] and Σ=ρI (where I is an identity matrix). Accordingly, each data sample xᵢ=[c₁, rᵢ], where cᵢ was a credit feature and rᵢ was a risk feature. A loan approval label yᵢ was assigned to each data sample xᵢ with the following rule:

$${y}_{i} = \{ \begin{matrix}1 , & \vert {c}_{i} + {r}_{i} \vert < 1 and \vert {c}_{i} - {r}_{i} \vert < 1 \\ 0 , & \vert {c}_{i} + {r}_{i} \vert < 1 and \vert {c}_{i} - {r}_{i} \vert \geq 1\end{matrix} . \qquad ( 6 )$$

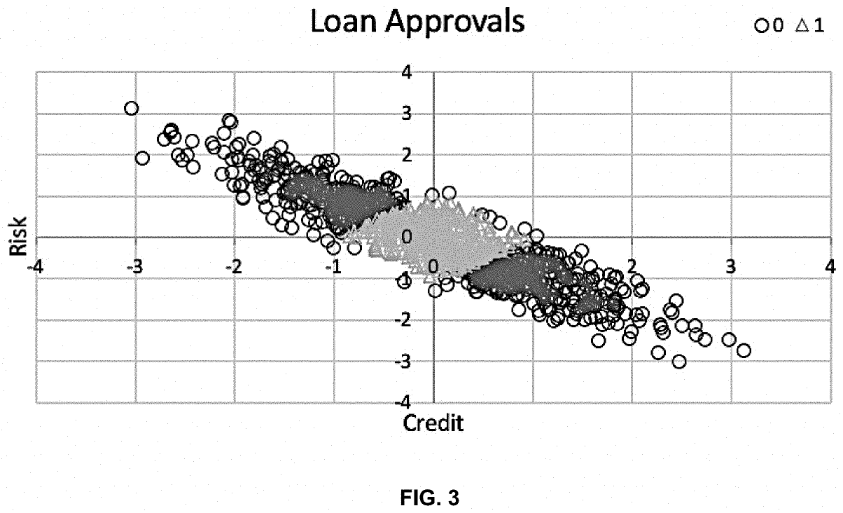

The loan approval dataset was simulated according to the above rule. The loan approval dataset is presented in FIG. 3.

In the above dataset, the full relationship between the credit feature and the rule feature was taken to be known to the subject matter experts employing the explanation models. As the credit and the risk were the only features, a business process rule was the bivariate Gaussian distribution: xᵢ˜ [symbol] (μ, Σ).

A loan approval model M was formulated such that the loan approval model M was highly accurate on samples that conform to the distribution shown in FIG. 3 and the loan approval model M was random on samples that do not conform to the distribution shown in FIG. 3. The loan approval model M performed well on real world, process conforming samples; however, the loan approval model M performed poorly on impossible, process non-conforming samples. Given the label assignment function yᵢ, the probability density function ρ(x) of a bivariate Gaussian distribution D, and the Bernoulli distribution Ber(p), the loan approval model M was defined as follows:

$$M ( {x}_{i} ) = \{ \begin{matrix}{y}_{i} , & p ( {x}_{i} ) \geq 0 \text{.01} \\ Ber ( 0.5 ) , & p ( {x}_{i} ) < 0 \text{.01}\end{matrix} . \qquad ( 7 )$$

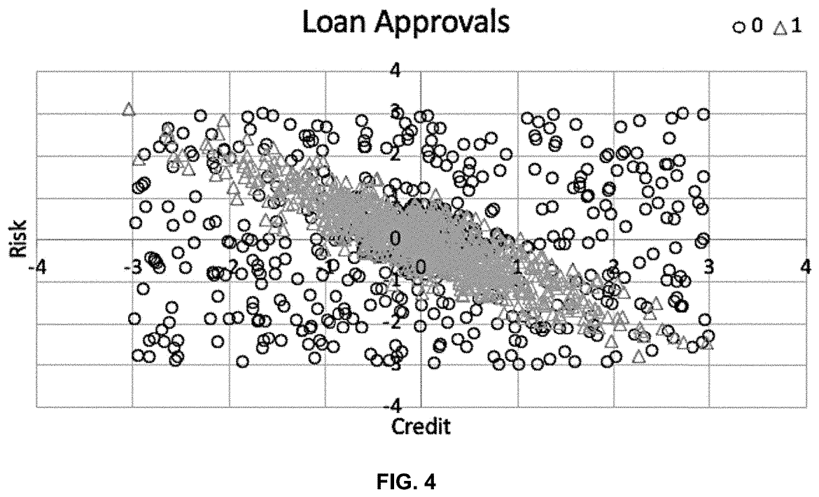

The behavior of loan approval model M on a uniform range of data points is illustrated in FIG. 4. It can be observed that there was only a clearly delineated globally nonlinear but locally linear decision boundary for data points fell within the bivariate Gaussian distribution D. As the in-distribution decision boundary follows the label assignment, it was defined in each quadrant as:

quadrant I: 1−Credit−Risk=0, (8)

quadrant II: 1+Credit−Risk=0, (9)

quadrant III: 1+Credit+Risk=0, (10)

quadrant IV: 1−Credit+Risk=0. (11)

While real world business process management (BPM) models are unlikely to be perfectly accurate on in-distribution, process conforming examples, the accuracy of a model should not significantly affect local interpretable model-agnostic explanations as the true labels are not used in learning the local linear model. Real world BPM models are also unlikely to behave perfectly randomly on out-of-distribution, process nonconforming samples; they may behave randomly or systematically in a way that may obfuscate the decision boundary near neighboring process conforming samples to a greater or lesser degree. This means that the severity of the out-of-distribution problem may vary on a per-application basis. We chose to study it with this simulation in the extreme case to better understand and improve on worse case behavior of local interpretable model-agnostic explanations in BPM settings.

The loan approval model M had a linear decision boundary in each quadrant on in-distribution, process conforming data points. Then, for a test set of data, we had a ground truth local linear boundary of M defined by these quadrant-wise linear components. We thus hoped that local interpretable model-agnostic explanations result from local linear models that matched these ground truth linear components. Accordingly, we measured the accuracy of local interpretable model-agnostic explanations using the coefficient mismatch metric. Coefficient mismatch measured the average absolute differences between the coefficients of the learned local linear model (fᵢ) and the ground truth linear component of M closest to xᵢ. By this definition, coefficient mismatch could take on any value in [0, [symbol] ] where the closer it was to 0, the more accurate the explanation was.

Let us consider an example to better illustrate coefficient mismatch. In this example, feature values of xᵢ was 0.41 for the credit and −0.51 for the risk; these values placed xᵢ in the fourth Cartesian quadrant. The ground truth linear component of M in the fourth quadrant was equation (11), where the coefficients of the credit and the risk were −1 and 1, respectively. From the learned local linear model (fᵢ), the coefficient of the credit was −0.66 and the coefficient of the risk was 0.69. Thus, coefficient mismatch was 0.34 for the credit and 0.31 for the risk.

We compared LIME with standard neighborhood sampling with extended LIME with process-aware neighborhood sampling (both sampling methods were over 100 trials), across neighborhood sizes of 1000 and 5000 samples. In the experiments, we averaged values over multiple trials. Table 1 presents coefficient mismatch of both LIME with standard neighborhood sampling and extended LIME with process-aware neighborhood sampling. As summarized in Table 1, we observed that extended LIME with process-aware sampling resulted in consistently lower coefficient mismatch scores for both features, indicating that extended LIME with process-aware sampling yields more accurate explanations. We further observed that this trend prevailed even when we reduced the neighborhood size, suggesting that extended LIME with process-aware sampling required fewer samples to attain a fixed level of explanation accuracy; in other words, extended LIME with process-aware sampling was more computationally efficient.

TABLE 1

| | |
|---|---|
| Credit | Risk |

|Nᵢ| = 1000

| | | |
|---|---|---|
| Standard | 0.95 ± 1.01 | 0.99 ± 1.03 |
| Process-Aware | 0.76 ± 0.72 | 0.78 ± 0.80 |

|Nᵢ| = 5000

| | | |
|---|---|---|
| Standard | 1.46 ± 3.89 | 2.61 ± 11.47 |
| Process-Aware | 0.63 ± 0.54 | 0.69 ± 0.77 |

FIG. 5 is diagram illustrating components of a computing device or server 500, in accordance with one embodiment of the present invention. It should be appreciated that FIG. 5 provides only an illustration of one implementation and does not imply any limitations with regard to the environment in which different embodiments may be implemented.

Referring to FIG. 5, computing device or server 500 includes processor(s) 520, memory 510, and tangible storage device(s) 530. In FIG. 5, communications among the above-mentioned components of computing device or server 500 are denoted by numeral 590. Memory 510 includes ROM(s) (Read Only Memory) 511, RAM(s) (Random Access Memory) 513, and cache(s) 515. One or more operating systems 531 and one or more computer programs 533 reside on one or more computer readable tangible storage device(s) 530.

Computing device or server 500 further includes I/O interface(s) 550. I/O interface(s) 550 allows for input and output of data with external device(s) 560 that may be connected to computing device or server 500. Computing device or server 500 further includes network interface(s) 540 for communications between computing device or server 500 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of a local explanation framework for explaining black-box machine learning models using a process-aware neighborhood sampling procedure.

What is claimed is:

1. A computer-implemented method for explaining black-box machine learning models, the method comprising:
determining a process-aware neighborhood around a data sample, using one or more business process rules;
computing proximity between the process-aware neighborhood and the data sample, using a process-aware distance metric;
finding, from a family of linear functions, a local linear model, by minimizing losses between respective ones of the linear functions and a black-box machine learning model; and
providing the local linear model for explanation of output of the black-box model on the data sample.

2. The computer-implemented method of claim 1, further comprising:
receiving the data sample, the black-box machine learning model, the one or more business process rules, the process-aware distance metric, and hyperparameters.

3. The computer-implemented method of claim 2, wherein the hyperparameters include parameters of the one or more business process rules.

4. The computer-implemented method of claim 1, wherein minimizing the losses is weighted with the proximity.

5. The computer-implemented method of claim 1, further comprising:
in finding the local linear model, penalizing linear model complexity.

6. The computer-implemented method of claim 1, further comprising:
providing feature coefficients of the local linear model for the explanation of the output of the black-box model on the data sample.

7. The computer-implemented method of claim 1, wherein the process-aware distance metric is a distance metric that is suitable for a data distribution corresponding to the one or more business process rules.

8. A computer program product for explaining black-box machine learning models, the computer program product comprising a computer readable storage medium having program instructions embodied therewith, the program instructions executable by one or more processors, the program instructions executable to:
determine a process-aware neighborhood around a data sample, using one or more business process rules;
compute proximity between the process-aware neighborhood and the data sample, using a process-aware distance metric;
find, from a family of linear functions, a local linear model, by minimizing losses between respective ones of the linear functions and a black-box machine learning model; and
provide the local linear model for explanation of output of the black-box model on the data sample.

9. The computer program product of claim 8, further comprising the program instructions executable to:
receive the data sample, the black-box machine learning model, the one or more business process rules, the process-aware distance metric, and hyperparameters.

10. The computer program product of claim 9, wherein the hyperparameters include parameters of the one or more business process rules.

11. The computer program product of claim 8, wherein minimizing the losses is weighted with the proximity.

12. The computer program product of claim 8, further comprising program instructions executable to:
in finding the local linear model, penalize linear model complexity.

13. The computer program product of claim 8, further comprising program instructions executable to:
provide feature coefficients of the local linear model for the explanation of the output of the black-box model on the data sample.

14. The computer program product of claim 8, wherein the process-aware distance metric is a distance metric that is suitable for a data distribution corresponding to the one or more business process rules.

15. A computer system for explaining black-box machine learning models, the computer system comprising:
one or more processors, one or more computer readable tangible storage devices, and program instructions stored on at least one of the one or more computer readable tangible storage devices for execution by at least one of the one or more processors, the program instructions executable to:
determine a process-aware neighborhood around a data sample, using one or more business process rules;
compute proximity between the process-aware neighborhood and the data sample, using a process-aware distance metric;
find, from a family of linear functions, a local linear model, by minimizing losses between respective ones of the linear functions and a black-box machine learning model; and
provide the local linear model for explanation of output of the black-box model on the data sample.

16. The computer system of claim 15, further comprising the program instructions executable to:
receive the data sample, the black-box machine learning model, the one or more business process rules, the process-aware distance metric, and hyperparameters; and
wherein the hyperparameters include parameters of the one or more business process rules.

17. The computer system of claim 15, wherein minimizing the losses is weighted with the proximity.

18. The computer system of claim 15, further comprising the program instructions executable to:
in finding the local linear model, penalize linear model complexity.

19. The computer system of claim 15, further comprising the program instructions executable to:
provide feature coefficients of the local linear model for the explanation of the output of the black-box model on the data sample.

20. The computer system of claim 15, wherein the process-aware distance metric is a distance metric that is suitable for a data distribution corresponding to the one or more business process rules.
